(19) United States
(12) Patent Application Publication
(10) Pub. No.: US 2025/0189747 A1
(43) Pub. Date: Jun. 12, 2025

(54) COMPACT FIBRE STORAGE AND DISTRIBUTION MODULE AND SYSTEM

(71) Applicant: THE LAN WIREWERKS RESEARCH LABORATORIES INC., Baie-d'Urfé, Québec (CA)

(72) Inventors: Simon VIGNEAULT, Rigaud, Québec (CA); Edouard TABET, St-Phillipe, Québec (CA)

(73) Assignee: THE LAN WIREWERKS RESEARCH LABORATORIES INC., Baie-d'Urfé, QC (CA)

(21) Appl. No.: 18/856,528

(22) PCT Filed: Apr. 11, 2023
(86) PCT No.: PCT/CA2023/050495

§ 371 Date: Oct. 11, 2024

Related U.S. Application Data
(60) Provisional application No. 63/406,103, filed on Sep. 13, 2022.
(60) Provisional application No. 63/330,163, filed on Apr. 12, 2022.

(51) Int. Cl. G02B 6/44

(52) U.S. Cl. CPC G02B 6/4457

(57) ABSTRACT

The present invention provides a cable storage and distribution module comprising a housing, one or more cable reels and a mating assembly comprising a front mating sleeve holder having plurality of mating sleeves and a rear MPO back plate having one or more MPO adaptors. The cable reel(s) is/are mounted in a cable seat in the housing and the mating assembly is mounted in a mating assembly seat in the housing. The cable reel(s) is/are mountable in a locked or unlocked (freely rotating) position. The present invention also provides a cable storage and distribution system comprising one or more modules installed in a patch panel. The system provides a high fiber density in a compact space.

### FIELD OF THE INVENTION

The present invention pertains to the field of fiber optics and in particular to the management and storage of fiber optic cables.

### BACKGROUND

In the telecommunications industry, use of fiber optic cables for carrying transmission signals is rapidly growing. Fiber distribution frames are adapted to aid in the connection of fiber optic equipment. To connect fiber optic equipment in the fiber distribution frame or to connect fiber optic equipment between fiber distribution frames, fiber optic cable is routed between the fiber optic equipment and/or the fiber distribution frames.

The deployment of factory pre-terminated fiber optic cables is crucial for minimizing network downtime for cable installation. Factory pre-terminated fiber optic cables require accurate length measurements, therefore the lead time for production of the required cable must be also considered when planning the installation.

Where an extra length of cable is required, it is preferable to be able to manage the extra cable near the connection points when using factory pre-terminated fiber cables.

One prior art system for the storage and deployment of fiber optic cable is provided by CommScope (ADC) Rapid Fiber Panels and Cable Spools. The product stores up to a 200 ft of fiber cable coiled inside a panel. The maximum fiber density achieved using this system is 48 F/RU. This product also manages/stores one fiber cable per panel.

Another prior art product for the storage and deployment of fiber optic cable is provided by Clearfield Smart Route Infinity Panel. This product contains two rod assemblies inside the panel around which the fiber cable is wrapped.

However, as the length of fiber optic cable needed between the fiber optic equipment and/or the fiber distribution frames varies depending on the location of the equipment in the fiber distribution frame or the location of the fiber distribution frames, there is a need for a system offering the flexibility of managing varying lengths of fiber optic cable in an effective and efficient manner.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a compact fibre storage and distribution module and system. In accordance with an aspect of the present invention, there is provided a compact cable storage and distribution module comprising: one or more cable reels, each said cable reel comprising a reel and a cable spooled on the reel; a mating assembly comprising a front mating sleeve holder comprising plurality of mating sleeves and a rear MPO back plate comprising one or more MPO adaptors; and a housing comprising a front end, a back end, a reel seat located at the rear end of the housing, and a mating assembly seat located at the front end of the housing, wherein the mating assembly is retained in the mating assembly seat, and the reel seat is adapted to receive and retain the one or more cable reels in the reel seat, wherein each said cable reel is independently mountable in a first locked position or a second unlocked position, wherein the cable reel is prevented from rotating in the first locked position, and the cable reel in the second unlocked position freely rotates.

In accordance with another aspect of the present invention, there is provided cable storage and distribution system comprising: one or more cable storage and distribution modules of the present invention; and a patch panel configured to receive the one or more cable storage and distribution modules in respective module slots.

### BRIEF DESCRIPTION OF THE FIGURES

FIG. 1 illustrates a perspective top view of a fiber storage and distribution module, in accordance with one embodiment of the present invention.

FIG. 2 illustrates a perspective bottom view of a fiber storage and distribution module showing a cable reel in a first locked position, in accordance with one embodiment of the present invention.

FIG. 3 illustrates a perspective top view of a fiber storage and distribution module with the labeling plate in an extended position, in accordance with one embodiment of the present invention.

FIG. 4 illustrates a perspective top view of a fiber storage and distribution module including an alternate mating sleeve, in accordance with one embodiment of the present invention.

FIG. 5 illustrates a perspective bottom view of a fiber storage and distribution module with the cable reel removed from the reel seat, in accordance with one embodiment of the present invention.

FIG. 6 illustrates a perspective bottom view of a fiber storage and distribution module including the cable reel in a second unlocked position, in accordance with one embodiment of the present invention.

FIG. 7 is an exploded top view of the components of a fiber storage and distribution module, in accordance with one embodiment of the present invention

FIG. 8 illustrates a perspective top view of a fiber storage and distribution module including two cable reels, in accordance with one embodiment of the present invention.

FIG. 9 illustrates a perspective top view of a fiber storage and distribution module with the cable reels removed from the reel seats, in accordance with one embodiment of the present invention.

FIG. 10 illustrates a perspective top rear view of a fiber storage and distribution module including two cable reels, in accordance with one embodiment of the present invention.

FIG. 11 illustrates a perspective top view of a fiber storage and distribution module including two cable reels, showing front pulling capacity, in accordance with one embodiment of the present invention.

FIG. 12 illustrates a perspective top view of a patch panel, in accordance with one embodiment of the present invention.

FIG. 13 illustrates a perspective top view of a patch panel with front and rear covers removed, in accordance with one embodiment of the present invention.

### DETAILED DESCRIPTION OF THE INVENTION

As used herein, the term “about” refers to a +/−10% variation from the nominal value. It is to be understood that such a variation is always included in a given value provided herein, whether or not it is specifically referred to.

The terms “cable”, “fiber cable” and fiber optic cable” are used interchangeably in the present specification.

The abbreviation “MPO” stands for “multi-fiber push-on” and refers to a type of optical connector employed at the end of multi-core optical fibers.

The abbreviations “LC” and “SC” refer to types of fiber-optic connectors.

Unless defined otherwise, all technical and scientific terms used herein have the same meaning as commonly understood by one of ordinary skill in the art to which this invention belongs.

The present invention provides a compact cable storage and distribution module configured to store a length of fiber optic cable and allow the cable to be unwound to the length needed for a specific deployment. The modules of the present invention provide a system capable of higher fiber density and fiber length within a smaller footprint than achievable using prior art systems.

The cable storage and distribution modules of the present invention may be operated in multiple modes. The module may be operated in an unlocked mode, which allows the spooling and unspooling of the cable through rotation of the cable reel, or a locked mode, which prevents rotation cable reel, thus keeping the cable at a fixed length extension.

The module of the present invention is a slide-in fiber storage and distribution module configured for use in conjunction with a patch panel, wherein multiple modules can be deployed per panel. The modules can be conveniently inserted into and removed from the patch panel as required to achieve the desired configuration.

The present invention therefore provides a system wherein the cable is stored in the removable modules, instead of in the panel.

The modules also provide a convenient means to adjust the length of the cable as required. The modules of the present invention therefore simplify pre-terminated fiber optic cable deployments by eliminating the need for precise length measurements. This allows users to stock the same product for multiple deployments, eliminating the production time required.

In one embodiment, up to four modules can be deployed in one panel. In one embodiment, multiple patch panels can be stacked per unit. Accordingly, the fiber density achievable using the system of the present invention is higher than that typically achieved by prior art systems.

In one embodiment, the module comprises one or more cable reels, each comprising a reel and a cable spooled on the reel, a mating assembly comprising a front mating sleeve holder comprising plurality of mating sleeves and a rear MPO back plate comprising one or more MPO adaptors and a housing comprising a front end, a rear end, a reel seat located at the rear end of the housing, and a mating assembly seat located at the front end of the housing. The mating assembly seat is the portion of the housing configured to receive and retain the components of the mating assembly, and the reel seat is the portion configured to receive and retain the one or more cable reels.

In one embodiment, the module is configured to accommodate a single reel.

In one embodiment, the module is configured to accommodate two reels. In one embodiment, the reel seat is configured to accommodate the two cable reels in a forward and aft arrangement, wherein one cable reel is located at the rearward end of the module and the other cable reel is located in the inner section of the module, between the aft cable reel and the mating assembly.

In accordance with the present invention, the cable reel is mounted on a spindle configured to rotatably receive the cable reel. The cable reel may be mounted in either a first, locked position or a second, unlocked position. In the first, locked position, the cable reel is prevented from rotating, while in the unlocked position, the cable reel is able to freely rotate to spool or unspool the cable to the desired deployment length. Once the desired length has been reached, the cable reel may be removed from the reel seat, rotated/flipped over, and reinserted into the reel seat in the locked position.

The module of the present invention therefore comprises a locking mechanism which is engaged upon insertion of the cable reel in the locked position to prevent rotation of the cable reel.

The module of the present invention therefore allows deployment of the exact cable length desired, which eliminates the slack management and congestion issues that result from employing cable having unnecessary extra cable length.

Each cable reel is a single cable reel having one cable spooled thereon. In one embodiment, the total length of the cable spooled on the reel is from about 10 meters to about 40 meters. In one embodiment, the cable reel comprises a cable having a length of about 15 meters or about 30 meters.

In one embodiment, the cable comprises an outside end connector at a first end of the cable and an inside end connector at a second end of the cable. Each of the inside end and outside end connectors are MPO connectors, and the inside end connector is adapted for insertion into a respective MPO adaptor on the MPO back plate. The outside and inside end connectors are independently male or female connectors.

In one embodiment, the module is configured to deploy the cable(s) from the rearward end of the module, e.g., through the end of the reel seat. In another embodiment, the module is configured to deploy the cable through the front end of the module, e.g., through an opening in the mating assembly.

For those embodiments comprising more than one cable reel, the module is further provided with one or more cable slots located in the wall of the module to facilitate deployment of the cable from the inner cable reel.

In one embodiment, the module may be used in conjunction with an open spool comprising an additional length of cable, for those application requiring additional cable lengths. In one embodiment, the open spool comprises 500 meters of cable.

The diameter of the reel is sufficient to ensure proper bend radius, thus minimizing strain on the cable. In one embodiment, the reel is about 40 to about 50 mm in diameter. In one embodiment, the reel is about 43 mm in diameter.

In a preferred embodiment, the mating assembly components are slidably inserted into the mating assembly seat.

In a preferred embodiment, the housing comprises two walls extending forwardly from the reel seat to form the mating assembly seat. In one embodiment, the two walls further comprise linear guiding rails on an external surface.

In a preferred embodiment, each wall comprises a front holder assembly slot located on an internal surface of the wall adjacent to the front end of the module. The front holder assembly is adapted to slidably receive the front mating sleeve holder.

In a preferred embodiment, each wall also comprises a back plate assembly slot located on an internal surface of the wall intermediate the front end and the back end of the module. The back plate assembly slot is adapted to slidably receive the rear MPO back plate.

Once the front mating sleeve holder and back plate have been installed in the mating assembly seat, the mating assembly seat bottom cover can be installed. In one embodiment, the cover is installed by inserting the cover attachment flanges located on the module walls into corresponding slots on the cover.

In one embodiment, the front mating sleeve holder comprises a plurality of flush mounted LC or SC mating sleeves. In one embodiment, the sleeve holder is provided with a plurality of simplex, duplex or quad mating sleeves. In one embodiment, the sleeve holder is configured with 3× Quad mating sleeves. In another embodiment, the sleeve holder is configured with 6× Quad mating sleeves. In a preferred embodiment, the mating sleeves are LC mating sleeves.

The system of the present invention provides high fiber density in a compact space. For example, in a rack unit (RU) having a length of about 19 in. (about 482 mm) and about 1.75 in. (about 44.5 mm), it is possible to mount four modules having the following dimensions: width: about 4.08 in. (about 104 mm), height: about 1.57 in. (about 39.8 mm) and depth: about 9.79 in. (about 249 mm). If each module is provided with a 6× Quad configuration front mating sleeve (24 fibers per module), the resulting fiber density is 96 fibers per RU. If each module is provided with a 3× Quad configuration front mating sleeve (12 fibers per module), the resulting fiber density is 48 fibers per RU.

For systems employing a 6× Quad configuration front mating sleeve (24 fiber, 24 F), a module with a 15 m cable reel provides a cable storage capacity of 15 m per channel, and therefore up to 4×15 m total in a single four channel RU. For systems employing a 3× Quad configuration front mating sleeve (12 fiber, 12 F), a module with a 30 m cable reel provides a cable storage capacity of 30 m per channel, and therefore up to 4×30 m total in a single four channel RU.

In one embodiment, the module housing comprises a labeling plate on which labeling information can be written/provided. Providing a labeling plate on the upward facing surface of the module makes it easy to read fiber identification information without disturbing the fibers located at the front end of the module, however, the labeling plate may be located on either of the top or bottom surfaces of the module.

In one embodiment, the label plate is slidably extendable to allow visual access to information written on and/or underneath the label plate. When the labeling plate is in the extended position, information recorded on the label plate, such as test results and harness routing, are conveniently viewable when the module is installed in the patch panel.

In one embodiment of the present invention, there is provided a cable storage and distribution system comprising a patch panel employed in combination with one or more cable storage and distribution modules. In a preferred embodiment, the modules can be inserted into the patch panel from both the front and the rear of the patch panel. In one embodiment, the installation is carried out by sliding the module into place. In one embodiment, the two linear guiding rails on the walls of the housing engage complementary sliding guides on the module channels/openings to facilitate sliding insertion of the module into place in the patch panel.

It is understood that a patch panel can be installed in a horizontal or vertical orientation, so that the use of relative terms such as “upper” and “lower”, “upward” and “downward”, and “top” and “bottom” are used to describe orientations and locations relative to the patch panel itself, regardless of its orientation in space.

In one embodiment, module installation and removal do not require the use of tools. In one embodiment, the module is held in place through the use of secure click-in-place stops.

In one embodiment, the patch panel comprises a removable front panel cover, wherein removal of the front panel cover allows access to the mating sleeves of the one or more modules. Removal of the front panel cover also allows installation and removal of the modules from the front of the patch panel enclosure.

In one embodiment, the patch panel comprises a removable rear panel cover, wherein removal of the rear panel cover allows access to the cable reel end of the one or more modules. Removal of the rear panel cover also allows installation and removal of the modules from the rear of the patch panel enclosure.

In one embodiment, the module can be inserted with the open portion of the reel seat(s) facing in a direction that allows the interior portion of the reel seat(s) and the cable reels to be exposed for viewing and/or access when installed in the patch panel, i.e., with the cable reels facing in an upward orientation within the patch panel. In one embodiment, the module is configured for insertion into the patch panel with the cable reels facing in either an upward or downward orientation.

Accordingly, the module may be accessed, installed, and removed through the front or rear of the patch panel enclosure, allowing for quick and easy installation and maintenance routines.

Accordingly, in one embodiment, the modules are configured for spooling/unspooling of the cables through the front end of the housing or through the rear end of the housing.

The invention will now be described with reference to specific examples as depicted in the figures. It will be understood that the following examples are intended to describe embodiments of the invention and are not intended to limit the invention in any way.

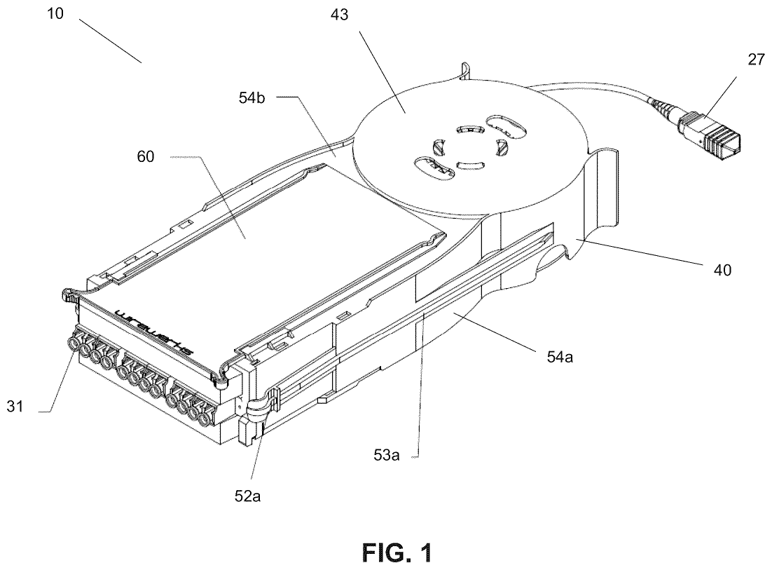

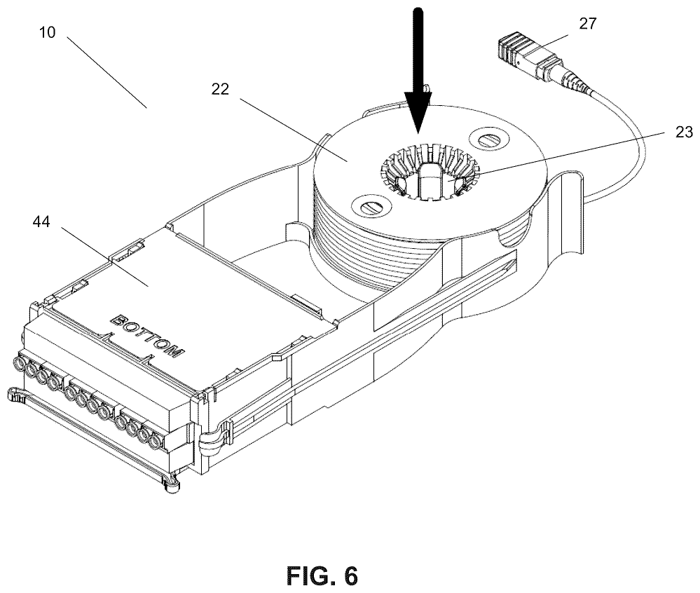

FIGS. 1 to 7 depict embodiments of a cable storage and distribution module of the present invention.

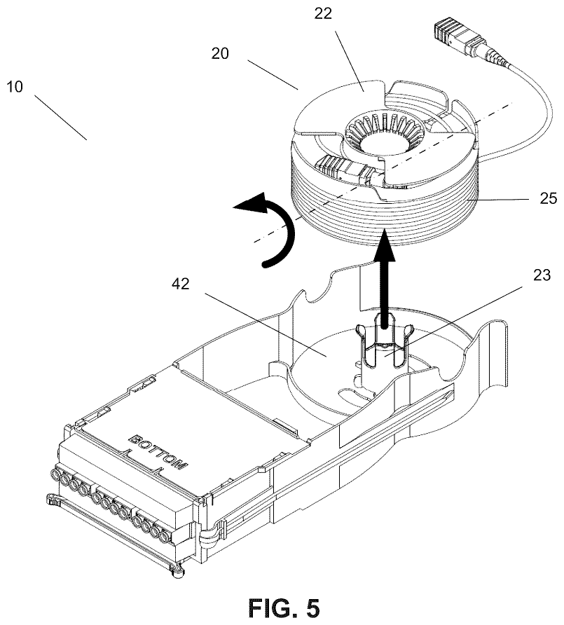

As depicted, module 10 comprises housing 40 having reel seat 42 adapted to receive cable reel 20 and housing walls 54a and 54b, which form a mating assembly seat adapted to receive mating assembly sleeve holder 30. Cable reel 20 comprises cable 25 spooled on reel 22, cable 25 having outside end connector 27 and inside end connector 26. Cable reel 20 is removably situated on spindle 23. Cable reel 20 may be removed from reel seat 42, rotated and replaced on spindle 23 such that the reel is convertible between a first locked position and a second unlocked position. FIG. 5 depicts the process for converting between locked and unlocked positions.

Housing walls 54a and 54b include on their external face guiding rails 53a and 53b, which are adapted to guide the insertion of the module into the patch panel.

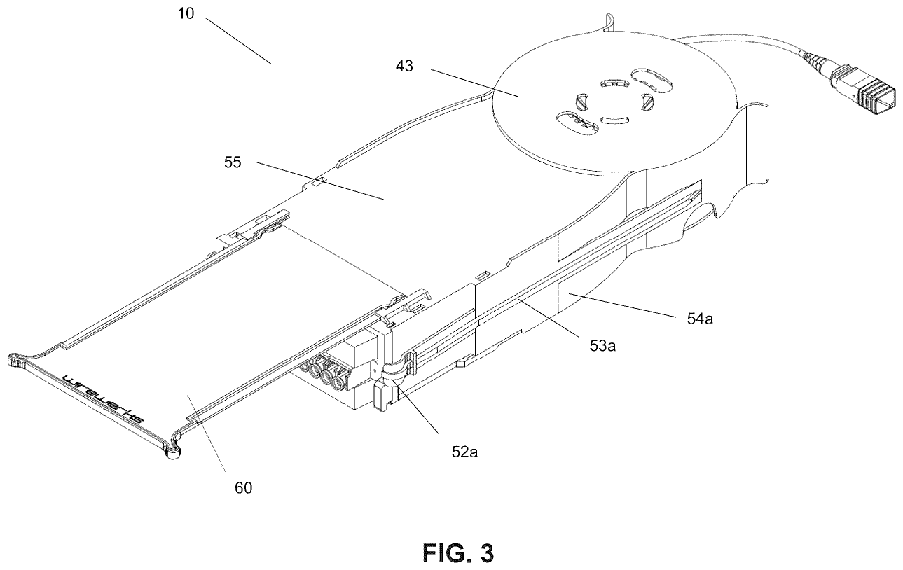

FIG. 3 depicts a module with label plate 60 in the extended position, exposing the underside of the mating assembly seat. Labeling information may be provided on label plate 60 and/or on mounting assembly seat bottom 55.

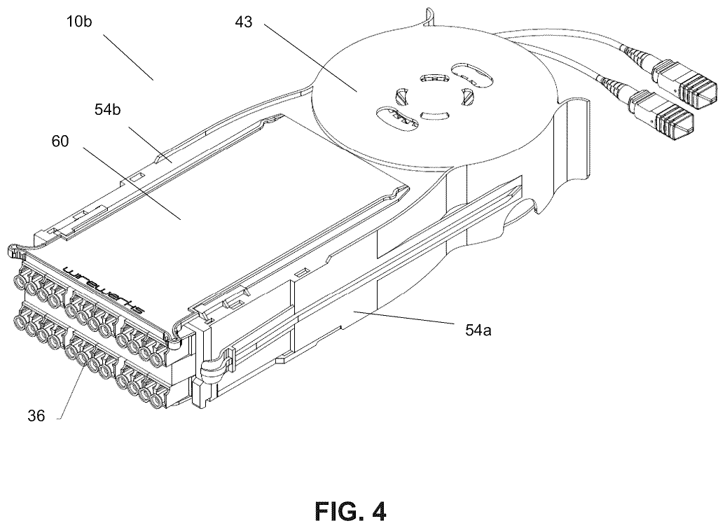

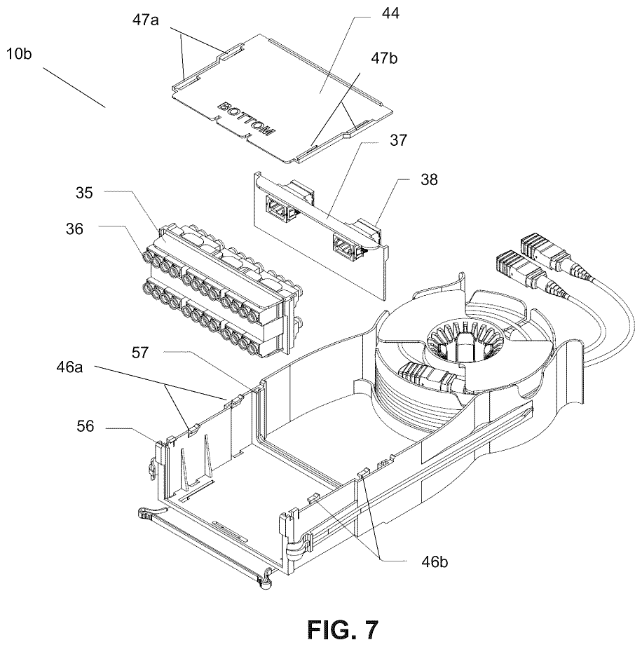

FIGS. 1, 2, 3, 5 and 6 depict a module 10 comprising a 3× quad mating sleeve holder 30 configuration and FIGS. 4 and 7 depict a module 10b comprising a 6× quad mating sleeve holder 35 configuration. Modules 10 and 10b employ the same housing which is configured to receive different mating sleeve holders and corresponding back plates.

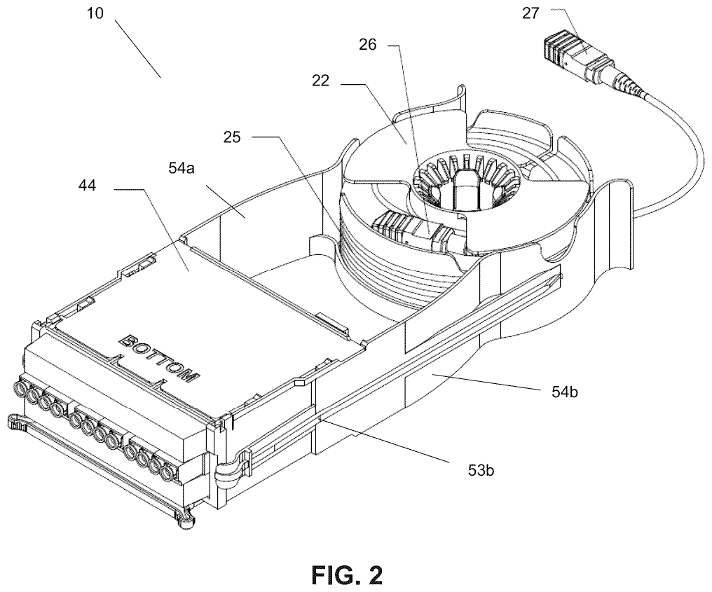

The bottom views in FIGS. 2, 5 and 6 show mating assembly seat bottom cover 44. FIG. 5 shows the interior of reel seat 42.

FIG. 7 provides an exploded view of the components of module 10b, showing the components of the mating assembly, including front mating sleeve holder 35 comprising a plurality of LC mating sleeves 36 and rear MPO back plate 37 comprising two MPO adaptors 38. Mating sleeve holder 35 and back plate 37 are inserted into the mating assembly seat by sliding into respective assembly slots 56 and 57 located on the inner surface of walls 54a and 54b. Once installed, bottom cover 44 is installed by inserting attachment flanges 46a and 46b into respective slots 47a and 47b located on cover 44 and clicking the cover into locking engagement.

Once module 10 or 10b has been assembled, it is ready for deployment in a patch panel.

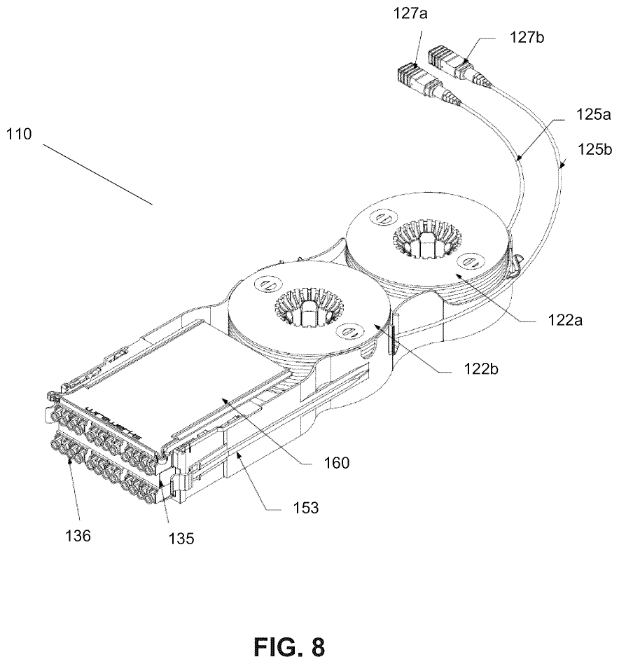

FIGS. 8 to 10 depict an alternative embodiment of a cable storage and distribution module 110 of the present invention, configured to accommodate two cable reels 120a, 120b in the cable seat. As depicted, module 110 comprises housing 140 having reel seats 142a, 142b adapted to receive cable reels 120a, 120b. Cable reels 120a, 120b comprise cables 125a, 125b spooled respectively on reels 122a, 122b. Cables 125a, 125b respectively have outside end connectors 127a, 127b. Cable reels 120a, 120b are removably situated on spindles 123a, 123b, and may be independently removed from reel seats 142a, 142b, rotated and replaced on spindles 123a, 123b such that each cable reel is convertible between a first locked position and a second unlocked position.

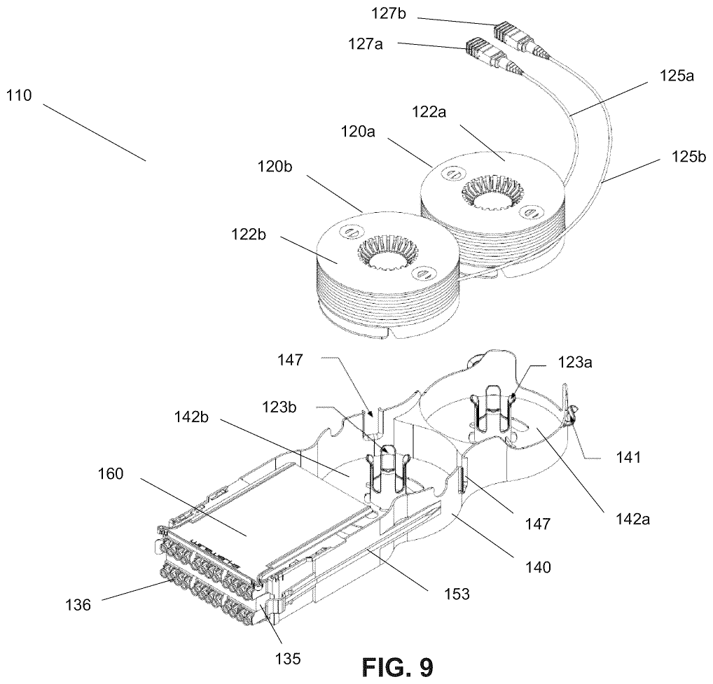

FIG. 9 provides an exploded view of the components of a module, showing the components of the mating assembly, including front mating sleeve holder 135 comprising a plurality of LC mating sleeves 136. Also shown are cable slots 147, located on side walls 140 of the module housing to allow for deployment of cable 125b from reel 122b, and cable guides 141 located at the rear of the housing to retain cable 125b once deployed.

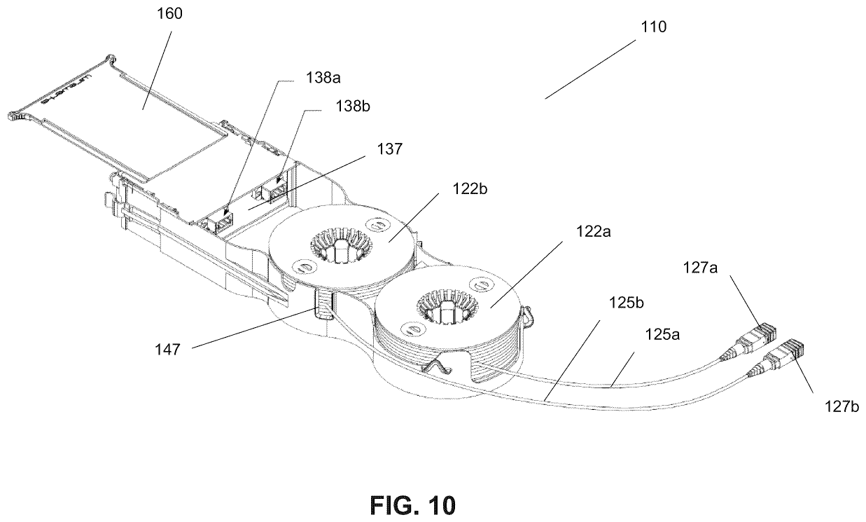

FIGS. 8 and 9 also depict label plate 160 in the retracted position and FIG. 10 depicts label plate 160 in the extended position.

FIG. 10 further depicts rear MPO back plate 137 comprising two MPO adaptors 138a, 138b.

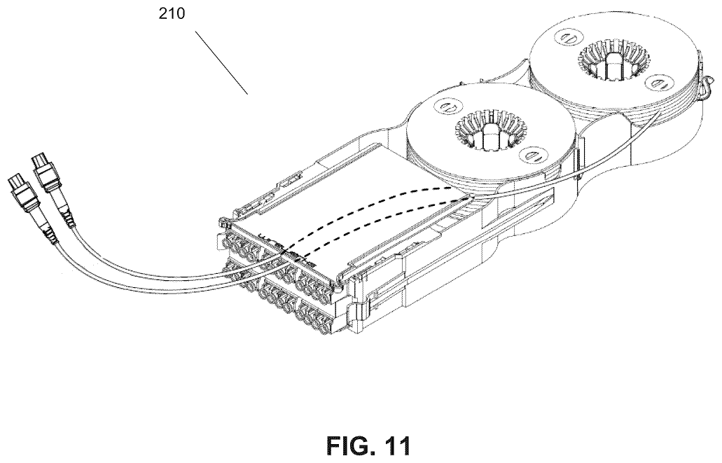

FIG. 11 depicts a further embodiment of a cable storage and distribution module 210, configured for front pulling capacity.

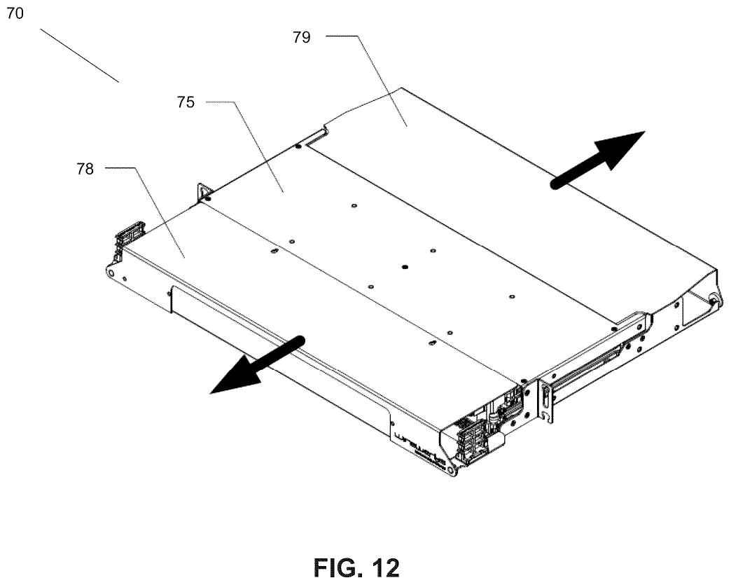

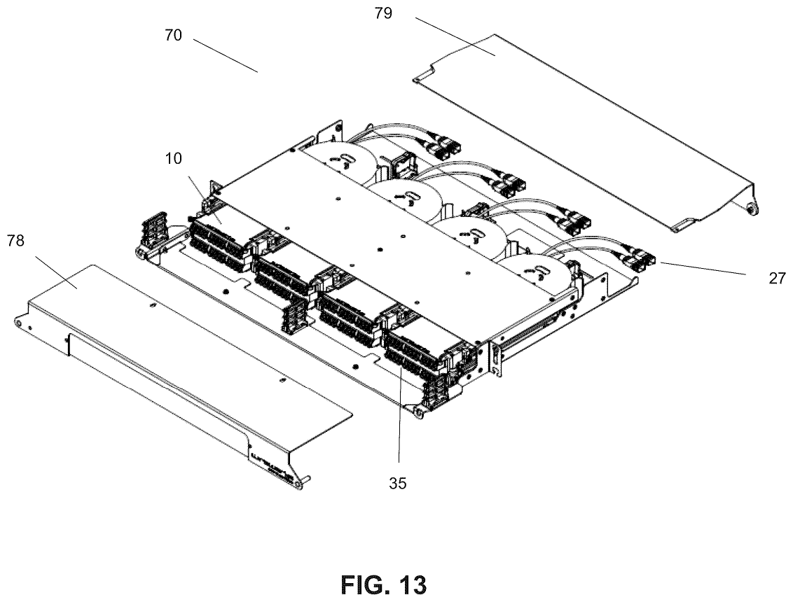

FIGS. 12 and 13 depict patch panel 70 in accordance with one embodiment of a system of the present invention. As shown in FIG. 9, front cover 78 and rear cover 79 have been removed to reveal four underlying modules 10. Removal of front cover 78 allows the user to access mating sleeve holders 35 and removal of rear cover 79 allows the user to access the end connector(s) 27 of cable 25.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

What is claimed is:

1. A cable storage and distribution module comprising:
one or more cable reels, each said cable reel comprising a reel and a cable spooled on the reel;
a mating assembly comprising a front mating sleeve holder comprising plurality of mating sleeves and a rear MPO back plate comprising one or more MPO adaptors; and
a housing comprising a front end, a back end, a reel seat located at the rear end of the housing, and a mating assembly seat located at the front end of the housing, wherein the mating assembly is retained in the mating assembly seat, and the reel seat is adapted to receive and retain the one or more cable reels in the reel seat,
wherein each said cable reel is independently mountable in a first locked position or a second unlocked position, wherein the cable reel is prevented from rotating in the first locked position, and the cable reel in the second unlocked position freely rotates.

2. The module of claim 1, comprising one cable reel.

3. The module of claim 1, comprising two cable reels.

4. The module of claim 1, wherein the mating assembly is slidably inserted into the mating assembly seat.

5. The module of claim 1, wherein the housing comprises two walls extending forwardly from the reel seat to form the mating assembly seat, wherein each wall comprises a front holder assembly slot and a back plate assembly slot located on an internal surface of the wall, wherein the front holder assembly slot is located adjacent to the front end of the module and is adapted to slidably receive the front mating sleeve holder, and wherein the back plate assembly slot is located intermediate the front end and the back end of the module and is adapted to slidably receive the rear MPO back plate.

6. The module of claim 5, wherein the two walls comprise linear guiding rails on an external surface.

7. The module of claim 1, wherein the reel seat comprises a spindle configured to receive the cable reel.

8. The module of claim 1, wherein the cable comprises an outside end connector at a first end of the cable and an inside end connector at a second end of the cable.

9. The module of claim 1, wherein the module comprises a locking mechanism configured to prevent rotation of the cable reel when the cable reel is placed in the reel seat in the first locked position.

10. The module of claim 1, wherein the housing further comprises a label plate on a top surface or a bottom surface of the housing.

11. The module of claim 10, wherein the label plate is slidably mounted on the housing.

12. A cable storage and distribution system comprising:
one or more cable storage and distribution modules as defined in claim 1; and
at least one patch panel configured to receive the one or more cable storage and distribution modules in respective module channels.

13. The system of claim 12, wherein the patch panel comprises a removable front panel cover, wherein removal of the front panel cover allows access to the mating sleeves of the one or more cable storage and distribution modules.

14. The system of claim 12, wherein the patch panel comprises a removable rear panel cover, wherein removal of the rear panel cover allows access to the cable reel of the one or more cable storage and distribution modules.

15. The system of claim 12, wherein the two linear guiding rails on the walls of the housing engage complementary sliding guides on the module channels.

16. The system of claim 12, wherein each patch panel comprises a rack unit (RU) having a length of about 19 in. (about 482 mm) and about 1.75 in. (about 44.5 mm), and each rack unit comprises four module channels.

17. The system of claim 12, wherein each module comprises a 6× Quad configuration front mating sleeve, wherein the system has a fiber density of 96 fibers per RU.

18. The system of claim 12, wherein each module comprises a 3× Quad configuration front mating sleeve, wherein the system has a fiber density of 48 fibers per RU.
